(19) United States
(12) Patent Application Publication
(10) Pub. No.: US 2018/0058427 A1
(43) Pub. Date: Mar. 1, 2018

(54) FLOATING BODY TYPE OFFSHORE WIND-POWER GENERATOR

(71) Applicant: OKYA Inc., Naka-gun (JP)

(72) Inventor: Masaru KANNO, Naka-gun (JP)

(73) Assignee: OKYA Inc., Naka-gun (JP)

(21) Appl. No.: 15/550,958

(22) PCT Filed: Feb. 5, 2016
(86) PCT No.: PCT/JP2016/053455

§ 371 Date: Aug. 14, 2017

(30) Foreign Application Priority Data
Feb. 15, 2015 (JP) 2015-027059

(51) Int. Cl. F03D 9/32; F03D 13/25; B63H 9/04; B63B 35/44

(52) U.S. Cl. CPC F03D 9/32; F03D 13/25; F03D 9/11; B63B 35/44; B63H 9/04

(57) ABSTRACT

A floating body type offshore wind power generation is provided. An elongated floating body is provided with a sail and a rudder, and a wind-power generator and a battery are provided on the floating body. These are provided with a GPS and a communication facility, and are capable of determining and moving to places having good wind conditions. The floating body can travel in both directions in a longitudinal direction and can travel also to the windward, and is capable of staying at substantially the same position by repeating the movement in a switchback manner, so that the same function as a moored floating body type wind power generation is also achieved. Generated power is accumulated in the battery or the like and the power is extracted on a site of use such as the land for use.

### TECHNICAL FIELD

The present invention relates to a floating body type offshore power generator provided on the ocean, configured to travel to the windward by controlling a direction of travel with a rudder by using wind power received by a sail provided on a movable floating body and resisting power of a centerboard with respect to water, and capable of staying at a fixed point without being drifted to the leeward in a switchback manner without being fixed to a land or the sea bottom and of moving to a position having high power generation efficiency depending on meteorological phenomenon and hydrographic phenomenon.

### BACKGROUND ART

In the course of increasing usage of renewable energies, potential installation space for a wind-power generator other than the onshore installation as is the case of seacoast implantation type or offshore floating body type is increased.

The wind-power generator is preferably installed at places in good wind conditions, and hence there is only a limited installation space at onshore locations in Japan where mountainous districts occupy seventy percent of the land and thus less air flowing through. Even though the places have good wind conditions, an electric transmission facility needs to be established in parallel if it is far from power consumption spots, so that the burden of expenses is added. Accordingly, the wind-power generator is installed at seacoasts near the power consumption spots or easily connectable spots for power transmission, or on the ocean. There are many places having better wind conditions on the ocean than onshore locations as there is no geological formation or structure which blocks wind. At onshore locations, there are problems of potential conflicts between neighbors and a wind power generation business caused by a low frequency noise generated by rotation of windmills, a concern of impairment of the natural scenery, and bird strike which is an event that wild birds get caught in the rotation of the windmill.

There is also a proposal of a wind-power generator provided on a movable floating body on the ocean and configured to control a windmill so as to receive wind always at an angle of 90 degrees or −90 degrees with respect to a wind direction.

### CITATION LIST

### Patent Literature

PTL1: JP-A-2009-41477

### SUMMARY OF INVENTION

### Technical Problem

In consideration of installation of a wind-power generator, a surface area of land having conditions suitable for installation is limited in Japan having many mountainous districts. In order to increase the amount of production of electricity, the wind-power generator needs to be developed in places other than onshore locations.

Japan is a country through which many typhoons pass. The wind-power generator may be subjected to damages due to strong wind. When the site of installation is near the sphere of human habitation, falling objects may do damage to people, buildings, and cars. In addition, since repair costs of the equipment may be incurred, or a design having a strength that resists damage by a strong wind is required, wind power generating costs are increased. The same applies to examples of damages due to meteorological disasters such as lightning strikes and hails.

The wind-power generator is preferably installed at a place having good wind conditions. However, space which provides stable operations is limited at onshore locations in Japan due to impairment by mountainous districts. In flatland, problems to neighbors such as noises and low-frequency sounds are reported. There are areas having relatively good wind conditions on tops of mountains and peripheries thereof. However, the cost of installation of the equipment is higher than that required for the flatland. There are also concerns about damages caused by wind blast, subsistence of wild birds and the like.

There is a case where the wind-power generator is installed on the ocean. It is expected that stable wind conditions are ensured compared with that at onshore locations. In the case of the seacoast implantation type, the sea bottom around Japan has not many shoals, and hence the surface area suitable for installation is limited. As described above, there is a concern about noise problem for peripheral areas. A floating body equipment is moored off the coast and the wind-power generator is installed thereon, and verification is performed. Since there is no obstruction for wind therearound, achievement of further preferable wind conditions is expected. However, ambitious additional equipment such as mooring facility and electric power cables is required, and costs for power generation may increase. There is a concern about entanglement of fishing nets with chains for mooring or electric power cable, and negotiation with those concerned with the fishing industry will be required.

In order to enlarge an application of wind power energy, a method of generating power on the ocean having good wind conditions, causing no conflict with the onshore living areas and having a large surface area at low equipment cost, and causing no problem for those concerned with the fishing is desirable.

### Means for Solving the Problem

A self-controllable floating body is floated on the ocean, and a wind-power generator is installed thereon. A device such as a battery which accumulates energy is provided in parallel to accumulate electric power generated by the wind-power generator, then the battery is transported to the land, and then electric energy is extracted at a desired place.

The floating body is an elongated thin plate shape or a boat shape, and includes a sail for receiving wind, a mast for supporting the sail, a boom for maneuvering the sail, a centerboard for preventing the floating body from drifting to the leeward, and a rudder for steering a direction of navigation of the floating body. The centerboard has a weight required for preventing the floating body from turning over easily when the sail receives wind.

The sail is rotatable about an axis of the mast, and may be maneuvered by applying a force on the boom.

The floating body has a GPS for figuring out the position thereof for obtaining long term meteorological phenomenon information from a satellite communication or the like, determines a position having good wind conditions by itself, and moves to the position for power generation.

The traveling speed of the floating body may be adjusted by an opening angle of the sail with respect to a wind direction. A windward travel is achieved by an operation of the rudder and an operation of an opening angle between the floating body and the sail. The floating body has a target shape in the longitudinal direction and is capable of traveling to any directions in a longitudinal direction depending on a surface of the sail which receives wind.

The floating body can travel to the windward by an amount corresponding to the drift to cancel out a movement thereof caused by drifting to the leeward upon reception of wind and, by repeating forward and rearward movements in the longitudinal direction in a switchback manner, the floating body may stay at a substantially fixed position on the ocean.

Therefore, the floating body type wind-power generator of the present invention is capable of self-controlled navigation toward a desired place and is capable of staying at a desired position. Since the floating body becomes uncontrollable at places where wind is too weak or too strong for the performance of the floating body, the floating body selects to move from those places in advance.

### Advantageous Effects of Invention

In 2014, it is said that the construction cost for a moored floating body type offshore wind-power generator is one billion yen/MW. In order to improve power generation efficiency, the windmill tends to have an extremely large size, and thus if the equipment having several MW to 10 MW in size is constructed, a huge construction cost is required.

The specification of installation type windmill is determined by wind condition inspection of a place to be installed, and hence is not stereotypical. The sizes of components to be used may vary. Therefore, mass-production effect is not expected and cost reduction for power generator is difficult. The moored floating body type wind-power generator requires a huge cost for maintenance because the equipment is extremely large. For the floating body type wind-power generator of the present invention, an adequate size is studied from a viewpoint of mass productivity and maintainability, and the power-generating capacity is increased not in size of the windmill, but in number of the windmills. The cost reduction for components is considered to be possible by the mass-production effect.

The floating body type wind-power generator of the present invention may be realized even in a scale which allows a power generator having a size ranging from 0.1 to 10 kW to be mounted thereon for one floating body because a mooring facility and a connecting line are not required. It means that a floating body type wind-power generator may be installed without requiring a large scale initial cost.

### BRIEF DESCRIPTION OF DRAWINGS

FIG. 1 is a plan view of an example of the present invention.

FIG. 2 is a side view of the example of the present invention viewed in a direction of a longitudinal axis of a floating body.

FIG. 3 is a side view of the example of the present invention viewed in a direction of an orthogonal axis with respect to the longitudinal direction of the floating body.

FIG. 4 is a plan view (viewed from above) of a floating body portion of an application (1) of the present invention.

FIG. 5 is a plan view (viewed from below) of the floating body portion of the application (1) of the present invention.

FIG. 6 is a side view of the floating body portion of the application (1) of the present invention.

FIG. 7 is a plan view of a portion other than a floating body of the application (1) of the present invention.

FIG. 8 is a side view of the portion other than the floating body of the application (1) of the present invention viewed in a direction of a longitudinal axis.

FIG. 9 is a side view of the portion other than the floating body of the application (1) of the present invention viewed in a direction of an orthogonal axis with respect to a longitudinal direction.

FIG. 10 is a plan view of the application (1) of the present invention.

FIG. 11 is a side view of the application (1) of the present invention.

FIG. 12 is a plan view of an application (2) of the present invention.

FIG. 13 is a side view of the application (2) of the present invention viewed in a direction of a longitudinal axis of a floating body.

FIG. 14 is a side view of the application (2) of the present invention viewed in a direction of an orthogonal axis with respect to a longitudinal direction of the floating body.

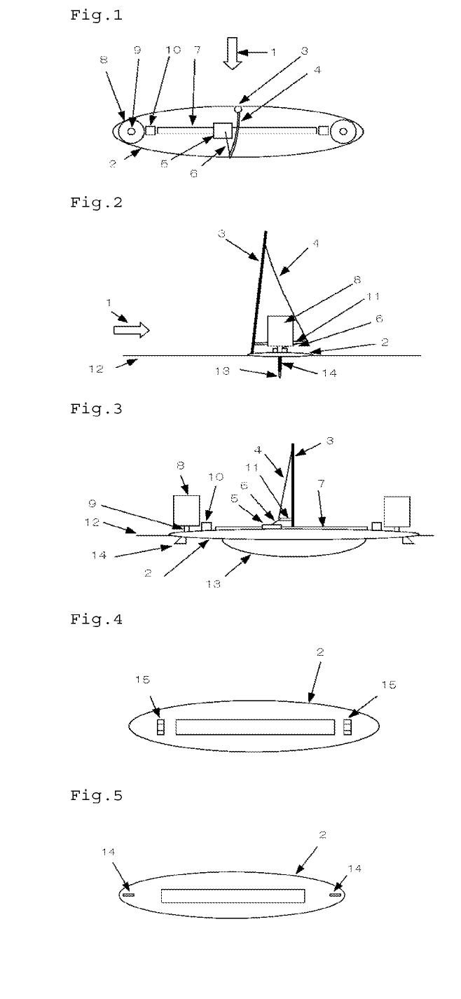

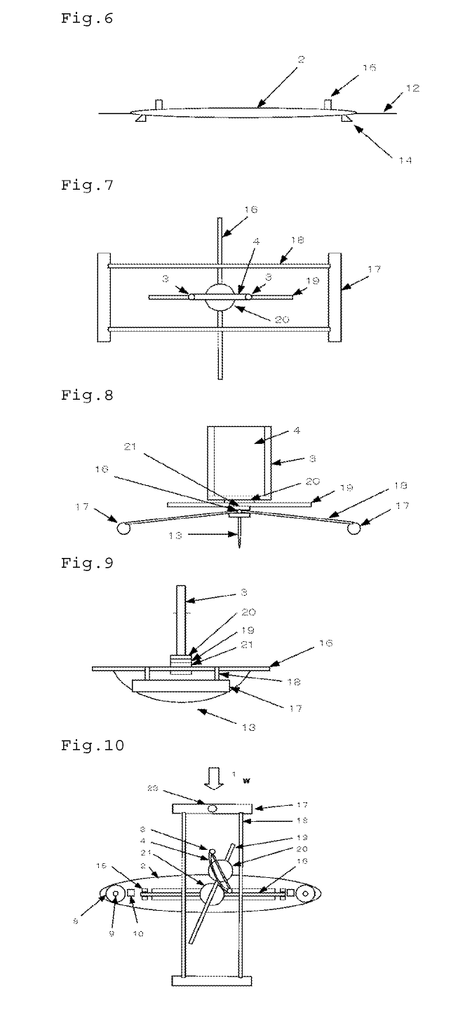

### DESCRIPTION OF EMBODIMENTS

A flat plate-shaped or a boat-shaped floating body elongated in one axis direction is provided on top thereof with a sail connected by a connecting body rotatable about an axis and extending upright, a centerboard for preventing lateral drifting provided under the floating body, and a rudder for steering in a direction of travel. The centerboard is assumed to have a weight sufficient for preventing the floating body from being overthrown when the sail receives wind. A pulley which can move on a rail for pulling a wire connected to a boom to allow an operation for opening the sail is laid. A wind-power generator and a battery for accumulating generated electric power are installed near both ends of the floating body in a longitudinal direction, respectively.

The floating body is assumed to receive wind at a right angle with respect to the longitudinal direction thereof on a side where the mast is provided upright when the wind blows from one direction. When the pulley moves in the longitudinal direction of the floating body, the sail is opened via the wire, and when the sail receives the wind, the floating body is pushed by the wind and travels along a direction of the centerboard provided under the water.

When the sail is widely opened and hence the amount of wind to be received is increased, the speed of travel of the floating body increases. When the sail is closed and hence the amount of wind to be received is decreased, the speed of travel of the floating body decreases. When the sail is closed and no more wind is received, the floating body stops.

By maneuvering the rudder while the floating body is traveling, the floating body may change the direction of travel to the windward or the leeward.

When the floating body traveling with the sail opened in one direction closes the sail and reduces the speed thereof sufficiently and then opens the sail now to the opposite side, the floating body travels in a direction opposite to the direction in which the floating body has been traveling until just a while ago.

By maneuvering the rudder to cause the floating body to move to the windward while repeating the reciprocal travel in a switchback manner and canceling out the amount of movement of the floating body generated by drifting to the leeward, the floating body stays at a substantially stationary position. Since the windmill may receive wind and generate electricity while staying at the substantially stationary position, the floating body type wind-power generator may be operated without necessity of a mooring facility.

The battery having electric power which is generated and accumulated therein is moved to a place of use, and the electric power is extracted therefrom.

### EXAMPLES

As illustrated in FIG. 1, FIG. 2, and FIG. 3, a floating body 2 having a round plate shape elongated in one axis direction is floating on a water surface 12. The floating body may have a boat shape. A mast 3 is provided upright on the floating body 2 and includes a boom 11 and a sail 4 so as to be rotatable about an axis of the mast. The floating body is provided on top thereof with a rail 7 laid along a longitudinal axis thereof and a pulley 5 that moves thereon, and an opening angle between the boom and the sail may be adjusted via a wire 6 by the movement of the pulley.

When wind 1 blows from a direction indicated by an arrow, and the sail is opened to receive the wind, the floating body travels in a direction of being pushed by the wind. The direction of travel follows a direction along a centerboard 13.

By maneuvering the rudder 14 while the floating body is traveling, the direction of travel of the floating body may be changed to the windward or to the leeward.

By closing the sail so as not to receive the wind while the floating body is traveling, the speed of travel of the floating body is reduced. By moving the pulley that pulls the boom to a direction opposite to the direction of movement up to then after the speed of travel of the floating body is reduced sufficiently, the sail receives wind on the opposite surface and the direction of travel of the floating body is reversed. When repeating this movement, the floating body may be reciprocated in a switchback manner.

By maneuvering the rudder to cause the floating body to travel to the windward while reciprocating the floating body to cancel out the amount of movement caused by drifting to the leeward, the floating body may be considered to be the same as staying at a substantially constant position.

The floating body is provided upright therefrom with power-generating windmills 8 via a windmill shaft 5 at both ends in the longitudinal axis direction. When the windmills rotate, electric power is generated. The generated electric power is accumulated in a battery 10.

Accordingly, the floating body type wind-power generator capable of generating electric power at a substantially constant position is realized without mooring the floating body to the land or the sea bottom.

The floating body type wind-power generator may be provided with a communication facility, a GPS, and a computer mounted thereon to determine positions with good wind conditions based on an estimation of meteorological phenomenon and generate electric power while moving with self-control. The instruments use the electric power generated thereby.

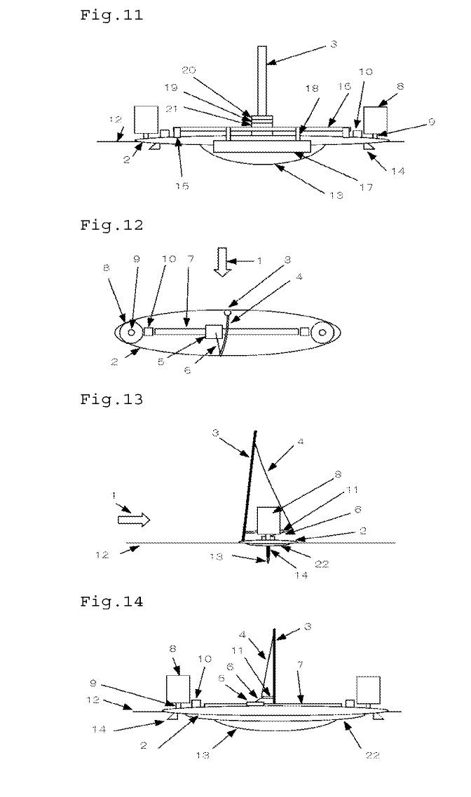

FIGS. 10 and 11 illustrate an application version of Example 1.

The floating body 2 receives the wind 1 on the board with respect to the longitudinal axis direction. On the ocean, waves are generated by the wind and lap onto the board, so that the floating body may swing. In order to receive the wind stably, the floating body and the sail are separated instead of being unified. The sail and the floating body are connected by placing a sail connection shaft 16 on a sail connection shaft fixing bracket 15. The sail connection shaft is capable of rotating about the shaft axis on the sail connection shaft fixing bracket. Therefore, the sail may be erected upright irrespective of the inclination of the floating body even though the floating body swings due to waves on the water surface.

The sail resists from falling down onto the water surface due to strong wind or unexpected wind because of the presence of an auxiliary floating body supporting arm 18 and an auxiliary floating body 17 attached to the sail connection shaft.

The sail 4 is provided upright on the floating body in a form of being extended on the mast 3 via a sail position moving rail rotating shaft 21 and a sail angle rotating table 20 that allow the sail position moving rail 19 to rotate with respect to the sail connection shaft. By adjusting the position and the angle of the mast with respect to the floating body, the floating body equipment may be balanced by moving a center of gravity while wind is blowing.

A wind direction and speed sensor 23 is installed on the windward to feed back obtained information to control or the like of the sail to achieve an optimal operation. The wind direction and speed sensor may be installed on the auxiliary floating body.

FIGS. 13, 14, and 15 illustrate an application version of Example 1.

The floating body 2 may reciprocate in a switchback manner by receiving wind on both surfaces of the sail alternately. A sub bottom surface 22 having a slightly smaller size in width and length than the floating body is mounted on the underwater surface of the floating body 2. In the case where a distal end in the direction of travel of the floating body floats above due to an increased strength of wind and speed of travel of the floating body, the sub bottom surface comes into contact with the water surface, and the front side in the direction of travel has a smaller water contact width than the rear side, so that a linearity of the travel may be increased.

In the examples described above, not only the wind-power generator, but also a photovoltaic facility may be mounted.

In the examples described above, instead of accumulating generated electric power in the battery, hydrogen generated from water by electrolysis may be accumulated as another energy.

### INDUSTRIAL APPLICABILITY

Since the floating body type wind-power generator may be installed on the ocean without fixing or mooring to the land or the sea bottom, a floating body type offshore wind-power generator may be developed at a lower cost even on the deep ocean far from the land.

### REFERENCE SIGNS LIST

1 wind direction
2 floating body
3 mast
4 sail
5 pulley
6 wire
7 rail
8 power-generating windmill
9 windmill shaft
10 battery
11 boom
12 water surface
13 centerboard
14 rudder
15 sail connection shaft fixing bracket
16 sail connection shaft
17 auxiliary floating body
18 auxiliary floating body supporting arm
19 mast position moving rail
20 sail angle rotating table
21 sail position moving rail rotating shaft
22 sub bottom surface
23 wind direction and speed sensor

1. A floating body type wind-power generator which is not moored or fixed to the land or the sea bottom, the equipment being configured to travel upon reception of wind on a sail provided upright on a round plate shaped which is elongated in one axis direction or a boat shaped floating body, and formed symmetrically in a longitudinal direction, having a mast for setting a sail provided upright at a position biased to a board which receives the wind, and allows changing in a direction of travel to the windward and to the leeward by maneuvering a rudder mounted on a bottom of the floating body, the floating body type wind-power generator being capable of generating electric power by using: a floating body equipment including communication means such as a GPS and a satellite connection that measure a position of the floating body and being capable moving to a position having desired good wind conditions based on a long-term meteorological phenomenon estimation and repeating a back-and-forth movement in a switchback manner by receiving wind on both surfaces of the sail alternately and moving to the windward by an amount corresponding to a movement caused by drifting to the leeward in a self-controlled manner to stay at a substantially stationary position, and a wind-power generator installed on the floating body equipment and a battery.

2. The floating body type wind-power generator according to claim 1, comprising an axially rotatable sail connection shaft provided in a longitudinal direction, wherein the sail swingable independently from the floating body via the sail connection shaft.

3. The floating body type offshore wind-power generator according to claim 1, comprising an auxiliary floating body for supporting the sail so as not to fall down due to strong wind or unexpected wind.

4. The floating body type offshore wind-power generator according to claim 9, wherein the sail is provided upright of the floating body in a form of being extended on the mast via the sail position moving rail with respect to the sail connecting shaft and a sail angle rotating table which is allowed to move and rotate on the sail position moving rail.

5. The floating body type offshore wind-power generator according to claim 1, comprising a sub bottom surface having a slightly smaller size in width and length than the floating body and provided on an underwater side of the floating body to enhance a linear traveling performance when a distal end in a direction of travel is floated above.

6. The floating body type offshore wind-power generator according to claim 1, comprising a wind direction and speed sensor on the windward of the floating body to acquire wind information that the sail will receive in advance to achieve an optimal sailing operation.

7. A floating body type photovoltaic facility comprising a photovoltaic facility mounted on the floating body type equipment according to claim 1.

8. A floating body type power generator configured to electrolyze water and accumulate hydrogen by using energy generated by the floating body type equipment according to claim 1.

9. A floating body type wind-power generator which is not moored or fixed to the land or the sea bottom, the generator being configured to travel upon reception of wind on a sail provided upright on a round plate shaped which is elongated in one axis direction or a boat shaped floating body, and formed symmetrically in a longitudinal direction, having a mast for setting a sail provided on a floating body so as to be changeable in upright position by moving on a sail position moving rail provided to be rotatable via a sail position moving rail rotating shaft, and allowing to change in a direction of travel to the windward and to the leeward by maneuvering a rudder mounted on a bottom of the floating body, the floating body type wind-power generator being capable of generating electric power by using: a floating body equipment including communication means such as a GPS and a satellite connection that measure a position of the floating body and being capable moving to a position having desired good wind conditions based on a long-term meteorological phenomenon estimation and repeating a back-and-forth movement in a switchback manner by receiving wind on both surfaces of the sail alternately and moving to the windward by an amount corresponding to a movement caused by drifting to the leeward in a self-controlled manner to stay at a substantially stationary position, and a wind-power generator installed on the floating body equipment and a battery.
